(19) United States
(12) Patent Application Publication
(10) Pub. No.: US 2002/0174268 A1
(43) Pub. Date: Nov. 21, 2002

(54) Method and apparatus for automatically linking distributed programming components

(76) Inventors: Philip J. Goward, Portland, OR (US); William J. Leler, Portland, OR (US)

Correspondence Address: PARK, VAUGHAN & FLEMING LLP, 508 SECOND STREET, SUITE 201, DAVIS, CA, 95616, US

(21) Appl. No.: 09/858,249

(22) Filed: May 15, 2001

(51) Int. Cl. G06F 9/00

(52) U.S. Cl. 709/331

(57) ABSTRACT

One embodiment of the present invention provides a system that interlinks distributed components during development of a distributed application. The system operates by determining a set of dependencies between distributed components that make up the distributed application, wherein a dependency between a first distributed component and a second distributed component indicates that the first distributed component refers to the second distributed component. Next, the system ensures that each distributed component that depends on a remote distributed component located on another computer system has a reference to the remote distributed component. In this way, a developer of the distributed application does not explicitly communicate references between the distributed components in order to interlink the distributed components.

### RELATED APPLICATION

The subject matter of this application is related to the subject matter in a co-pending non-provisional application by inventors Philip J. Goward, William J. Leler and Catherine J. Benetz, entitled, “Automatically Propagating Distributed Components During Application Development,” having serial number TO BE ASSIGNED, and filing date TO BE ASSIGNED (Attorney Docket No. WGB01-0004).

### BACKGROUND

1. Field of the Invention

The present invention relates to the process of designing applications for distributed computing systems. More specifically, the present invention relates to a method and an apparatus for interlinking distributed components during development of a distributed application.

2. Related Art

As the Internet continues to expand at an exponential rate, thousands of new web sites are coming on line every day selling products as diverse as books and automobiles, and offering services, such as stock trading and electronic banking. Unfortunately, deploying a web site of any sophistication can be an expensive and time-consuming task, requiring a large investment in expensive programmer time.

In order to remedy this problem, it is becoming increasingly common to build web applications using distributed components that are typically located on remote computing platforms. These distributed components can be used to perform computational tasks and other operations involved in implementing a web site. For example, a web server can communicate with a first distributed component located on a first application server to handle operations relating to shipping. At the same time the web server can communicate with a second distributed component located on a second application server to handle inventory operations. In this way, the web site can be deployed without having to write code to deal with shipping or inventory. Hence, using distributed components can greatly reduce the amount of work involved in developing a web application, and can thereby reduce cost.

Unfortunately, the task of authoring and debugging a distributed application can be a complicated task. After the components of a distributed application have been authored, some of the components may have to be deployed to remote computer systems for execution. This process is presently performed manually. Hence, a programmer must explicitly enter commands to transfer the distributed components to the remote computer systems and to install the distributed components at the remote computer systems. If the distributed application includes a large number of distributed components, this can be an extremely time-consuming and repetitive process.

Furthermore, whenever distributed components are subsequently modified during the development process, the modified distributed components must be re-deployed in the same manner.

What is needed is a method and an apparatus for automatically deploying distributed components that make up a distributed application.

### SUMMARY

One embodiment of the present invention provides a system that interlinks distributed components during development of a distributed application. The system operates by determining a set of dependencies between distributed components that make up the distributed application, wherein a dependency between a first distributed component and a second distributed component indicates that the first distributed component refers to the second distributed component. Next, the system ensures that each distributed component that depends on a remote distributed component located on another computer system has a reference to the remote distributed component. In this way, a developer of the distributed application does not explicitly communicate references between the distributed components in order to interlink the distributed components.

In one embodiment of the present invention, determining the set of dependencies involves constructing a dependency graph between distributed components that make up the distributed application.

In one embodiment of the present invention, the system additionally deploys the distributed components using an ordering derived from the dependency graph, so that a given distributed component is only deployed after distributed components upon which the given distributed component depends have been deployed and have returned references. In this way, the given distributed component can be deployed along with references to distributed components upon which it depends.

In one embodiment of the present invention, determining the set of dependencies involves examining a deployment specifier that indicates where each of the distributed components that make up the distributed application is to be deployed.

In one embodiment of the present invention, the distributed application is specified in terms of a component-behavior model. This component-behavior model specifies components, which are separately deployable pieces of software that can be used to make up an application. This component-behavior model also specifies behaviors that define a response to an event, wherein the response can include activating a component. In a variation on this embodiment, activating the component involves invoking a method defined by the component. In a variation on this embodiment, an event can be generated by a component or a behavior.

In one embodiment of the present invention, the distributed application is received after the distributed application has been modified during a development process. In this embodiment, determining the set of dependencies involves, determining changes to the set of dependencies caused by modifications to the distributed application, so that only dependencies that have been changed during the development process cause new references to be communicated.

In one embodiment of the present invention, prior to receiving the distributed application, the system allows the developer to author the distributed components that make up the distributed application, and to create a deployment specifier that indicates where each of the distributed components is to be deployed.

In one embodiment of the present invention, the distributed application is received during execution of the distributed application.

In one embodiment of the present invention, the distributed components can include, an Enterprise JavaBean (EJB), a Distributed Component Object Model (DCOM) object, or a Common Object Request Broker Architecture (CORBA) object.

In one embodiment of the present invention, a distributed programming component is an Enterprise JavaBean (EJB) that is encapsulated as a JavaBean by combining functionality of a home interface and a remote interface of the EJB into the JavaBean.

In one embodiment of the present invention, the system additionally identifies any distributed components within the distributed application that need to be deployed to remote locations. For each distributed component that needs to be deployed, the system identifies a remote location for the distributed component, and causes the distributed component to be deployed to the remote location.

One embodiment of the present invention provides a system that deploys a component-behavior model within a distributed computer system. Upon receiving a specification for the component-behavior model, the system determining a set of dependencies between components that make up the component-behavior model, wherein a dependency between a first component and a second component indicates that the first component refers to the second component. The system then ensures that each component that depends on a remote component located on another computer system has a reference to the remote component.

### BRIEF DESCRIPTION OF THE FIGURES

FIG. 1 illustrates a distributed computer system including a collection of servers that operate together in accordance with an embodiment of the present invention.

FIG. 2 illustrates the structure of a JavaBean that is used to encapsulate an Enterprise Java Bean (EJB) in accordance with an embodiment of the present invention.

FIG. 3 illustrates a capsule that specifies a component-behavior model in accordance with an embodiment of the present invention.

FIG. 4 presents a graphical representation of an exemplary capsule in accordance with an embodiment of the present invention.

FIG. 5 is a flow chart illustrating the process of deploying a distributed component in accordance with an embodiment of the present invention.

FIG. 6A illustrates a deployment server on a remote computer system in accordance with an embodiment of the present invention.

FIG. 6B is a flow chart illustrating the process of deploying a distributed component on a remote computer system in accordance with an embodiment of the present invention.

FIG. 7 illustrates the structure of a deployment specifier in accordance with an embodiment of the present invention.

FIG. 8 is a flow chart illustrating the process of deploying distributed components that make up a distributed application in accordance with an embodiment of the present invention.

FIG. 9 is a flow chart illustrating how references between distributed components are handled during the deployment process in accordance with an embodiment of the present invention.

FIG. 10A illustrates the structure of an exemplary distributed application in accordance with an embodiment of the present invention.

FIG. 10B is a flow chart illustrating how the exemplary distributed application is deployed in accordance with an embodiment of the present invention.

FIG. 10C illustrates how the exemplary distributed application operates in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Distributed Computer System

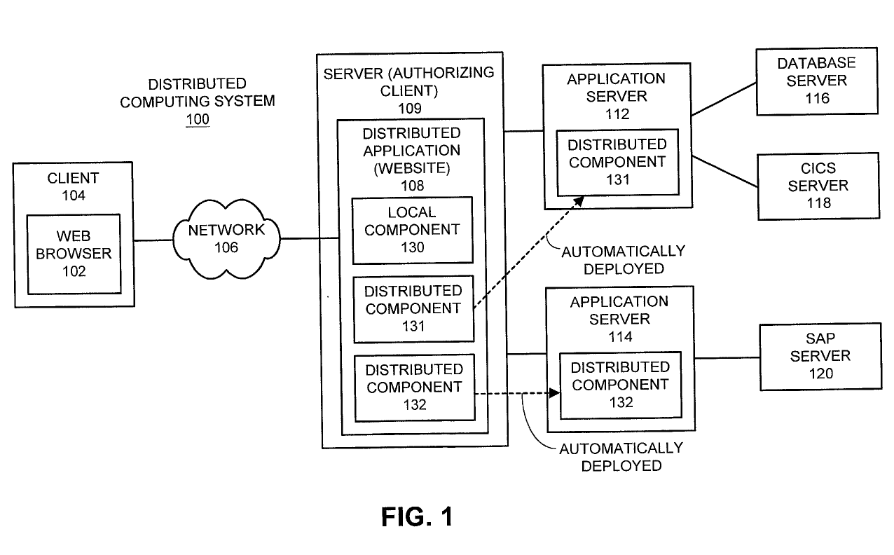

FIG. 1 illustrates a distributed computer system 100 including a collection of servers that operate together in accordance with an embodiment of the present invention. In FIG. 1, a client 104 communicates across network 106 with a distributed application 108 on a server 109. In one embodiment of the present invention, distributed application 108 is a web site, and client 104 includes a web browser 102 for communicating with the web site.

Client 104 can generally include any node on network 106 including computational capability and including a mechanism for communicating across network 106. Web browser 102 can generally include any type of web browser capable of viewing a web site, such as the INTERNET EXPLORER™ browser distributed by the Microsoft Corporation of Redmond, Wash.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Server 109 can generally include any computational node including a mechanism for servicing requests from a client for computational and/or data storage resources. In one embodiment of the present invention, server 109 is an authoring client that is used by a developer to write and debug distributed application 108.

Server 109 communicates with application servers 112 and 114 to perform some of the computational operations involved in implementing distributed application 108. Application servers 112 and 114 in turn communicate with other servers, such as database server 116, CICS server 118 and SAP server 120, to gather information and/or to perform other computational operations.

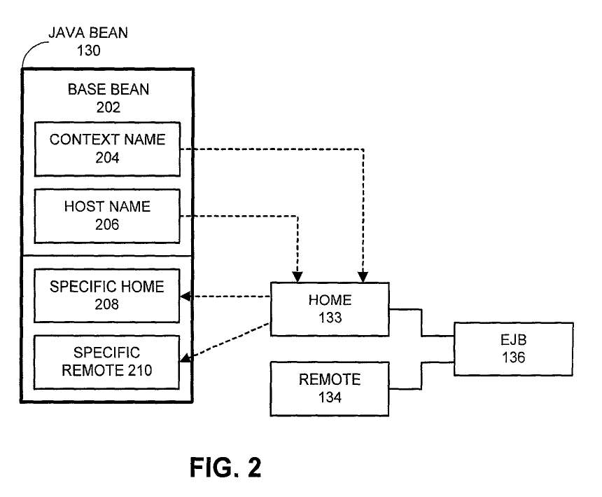

Distributed application 108 is made up of a number of components, including local component 130 and distributed components 131-132. Note that a “component” is a separately deployable piece of software that can be used by other components or applications, and that can remain resident on a computer system even if an application that uses the component is no longer active. During the development process, distributed component 131 is automatically deployed to application server 112 and distributed component 132 is automatically deployed to application server 114. This automatic deployment process is described in more detail below with reference to FIGS. 2-10C.

Note that the present invention generally applies to any computing system that uses distributed components, and is not meant to be limited to web-related applications.

Furthermore, the present invention generally applies to all distributed components, including EJBs, DCOM objects and CORBA objects. The present invention also generally applies to all local components, including JavaBeans and COM objects.

Encapsulation of a Distributed Component

Referring FIG. 1, note that distributed components 131-132 are encapsulated as local components on server 109. This allows an application developer to make use of distributed components 131-132 as if they are local components. This encapsulation can be accomplished in a number of ways.

For example, FIG. 2 illustrates the structure of a JavaBean 130 that is used to encapsulate an EJB 136 in accordance with an embodiment of the present invention. JavaBean 130 includes a base bean 202, which contains a context name 204 and a host name 206. Context name 204 can be used to identify EJB 136, and host name 206 can be used to identify application server 114 that contains EJB 136.

Context name 204 is communicated to the naming lookup service of the application server identified by host name 206 to return home interface 133 in order to create or find EJB 136. EJB 136, which is returned by create or find via home interface 133, implements remote interface 134, and is used to establish specific remote 210 within JavaBean 130 in order to facilitate communication within EJB 136.

Note that specific home 208 and specific remote 210 include methods that can be used to communicate through home interface 133 and remote interface 134 with EJB 136.

This encapsulation process is described in more detail in U.S. patent application Ser. No. 09/792,464 filed on Feb. 23, 2001 by inventors Philip J. Goward and William J. Leler, entitled “Encapsulating an Interface to a Distributed Programming Component as a Local Component.” The above-listed patent application is hereby incorporated by reference to describe the encapsulation process.

Capsule that Specifies a Component-Behavior Model

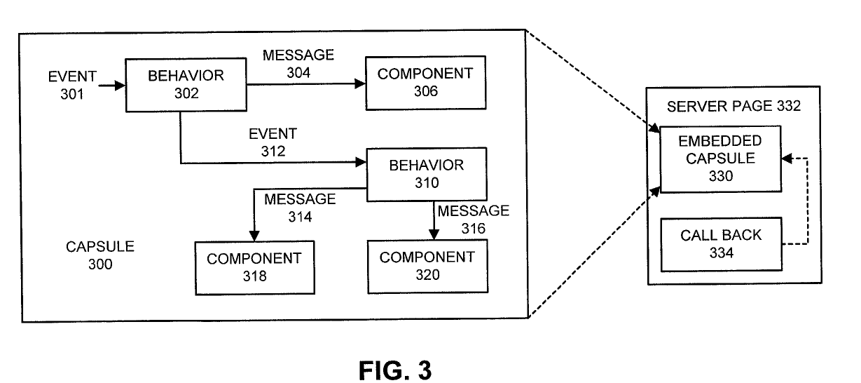

FIG. 3 illustrates a capsule 300 that specifies a component-behavior model in accordance with an embodiment of the present invention. Capsule 300 includes a number of inter-linked components (306, 318 and 320) and behaviors (302 and 310). Each of the behaviors 302 and 310 receives a stimulus in the form of an event 301 and 312, and generates a response in the form of one or more method invocations to the components 304, 314 and 316. (Note that an “event” is similar to an interrupt or a signal that is registered within the application.)

For example, a behavior 302 listens for an initial event 301. When initial event 301 occurs, behavior 302 sends a message 304 to component 306 by invoking a method defined within component 306. Behavior 302 may also generate an event 312 that feeds into another behavior 310.

Upon receiving event 312, behavior 310 executes a script that generates a number of messages 314 and 316. These messages 314 and 316 invoke methods within components 318 and 320.

In one embodiment of the present invention, capsule 300 is embedded into server page 332 in Extensible Markup Language (XML) form as embedded capsule 330. A callback 334 located within server page 332 is used to invoke a method defined within capsule 300.

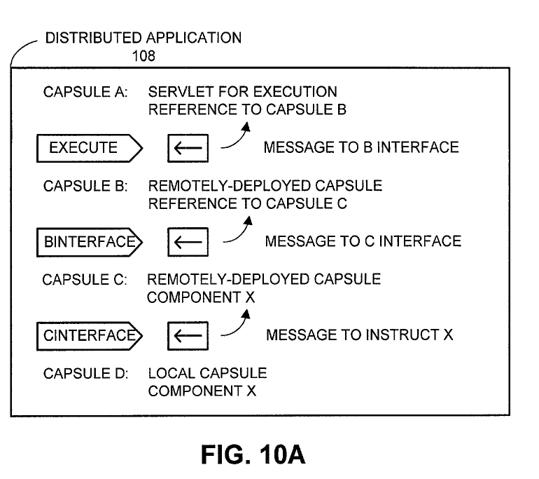

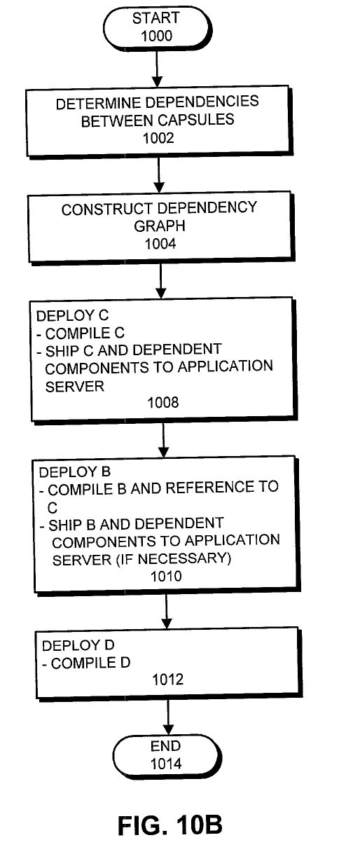

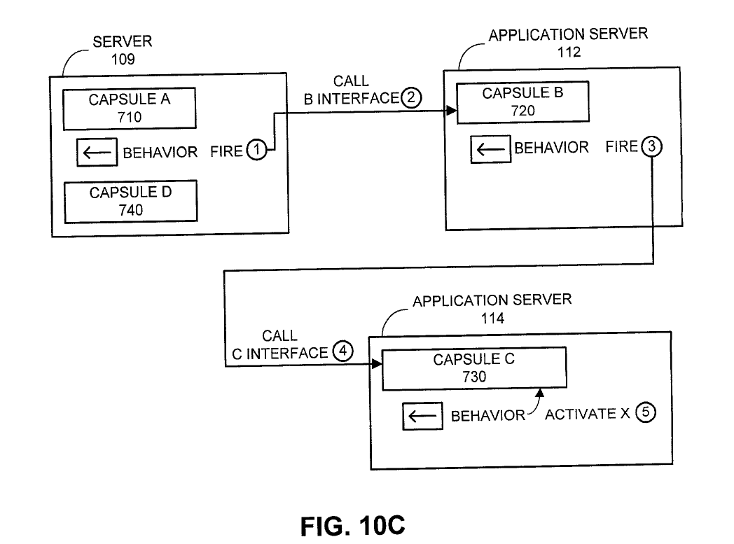

Note that a component-behavior model can also span a number of capsules located on different machines, in which case events are communicated between capsules to create interactions between components. Note that the component-behavior model provides an elegant mechanism for communicating between distributed components when only events are communicated between different machines. An example of how the present invention can be used to facilitate deploying a component-behavior model across a distributed system is described below with reference to FIGS. 10A-10C.

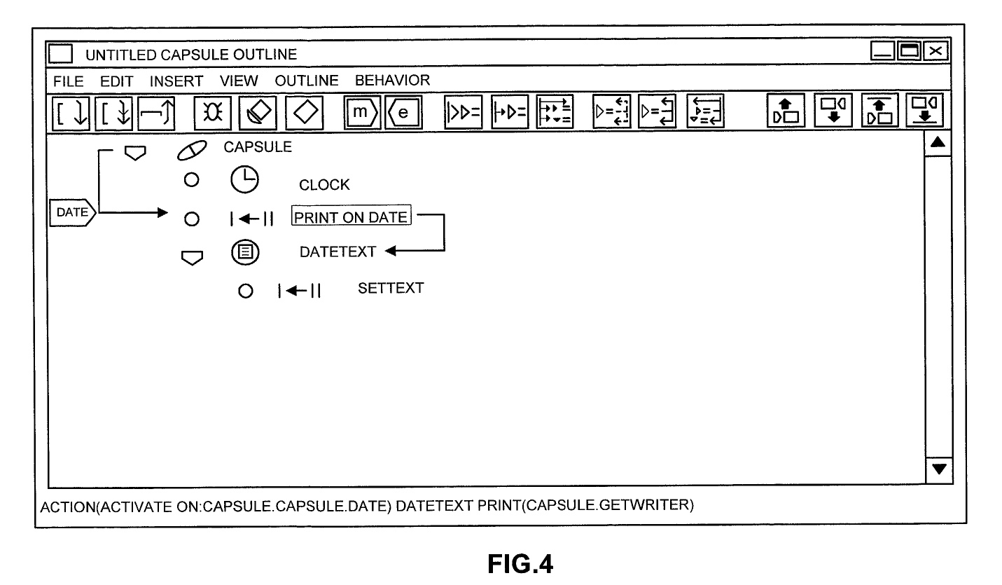

FIG. 4 presents a graphical representation of an exemplary capsule in accordance with an embodiment of the present invention. This graphical representation can be manipulated by entering commands through a graphical user interface.

Note that the graphical user interface appearing in FIG. 4 illustrates how a behavior, such as “print on date” is graphically linked to a component that causes a date to be outputted.

Deploying a Distributed Component

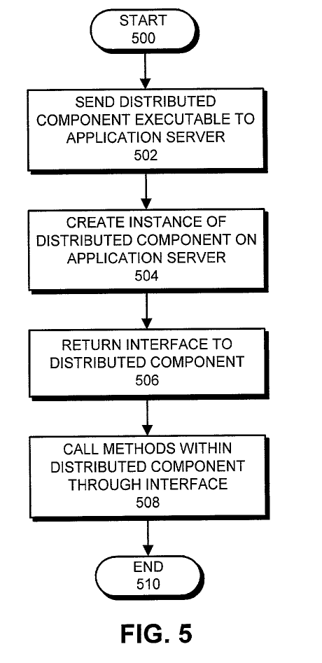

FIG. 5 is a flow chart illustrating the process of deploying a distributed component in accordance with an embodiment of the present invention. As is illustrated in FIG. 5, the executable code for distributed component 131 is sent from the authoring client 109 to an application server 112 that is to host the distributed component (step 502). Next, authoring client 109 causes application server 112 to create an instance of the distributed component on application server 112 (step 504). Server 109 then returns an interface to the newly created instance of the distributed component to authoring client 109 (step 506). This allows other components within distributed application 108 to subsequently invoke methods within distributed component 131 through the interface (step 508).

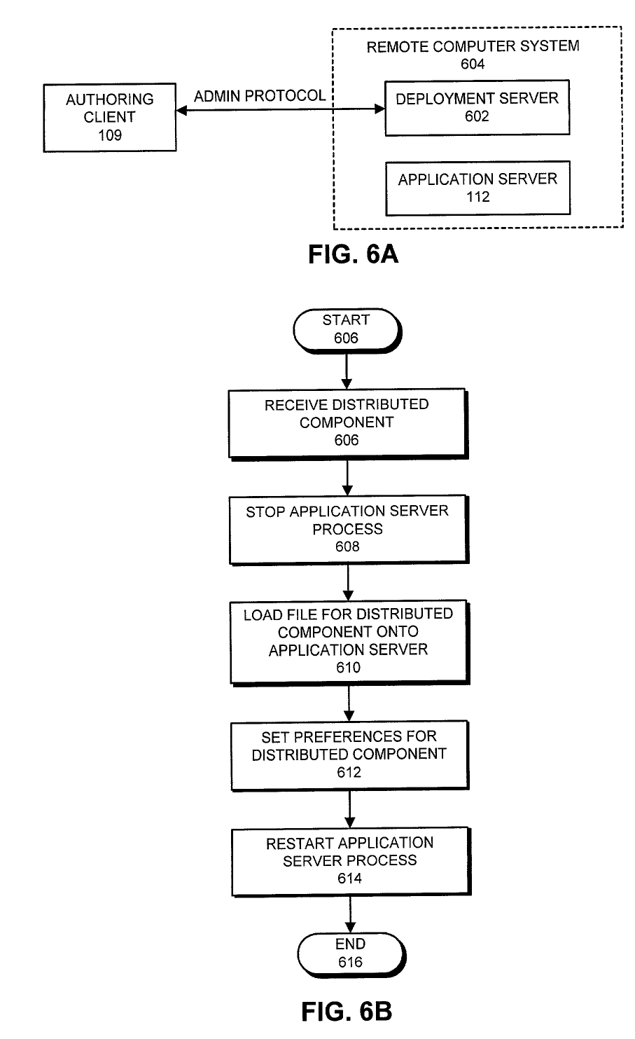

FIG. 6A illustrates a deployment server 602 on a remote computer system 604 in accordance with an embodiment of the present invention. Authoring client 109 communicates with deployment server 602 by using an administration protocol. This administration protocol facilitates loading a distributed component, such as an Enterprise Java Bean (EJB), onto application server 112. Note that some application servers come pre-configured to communicate through an administration protocol and do not need an additional deployment server 602.

FIG. 6B is a flow chart illustrating the process of deploying a distributed component on a remote computer system in accordance with an embodiment of the present invention. Upon receipt of a distributed component (step 606), the system stops the application server process (step 608). Next, the system loads files related to the distributed component into remote computer system 604 so that they are accessible by application server 112 (step 610). The system also sets preferences to configure application server 112 for deployment of the distributed component (step 612). Finally, the system restarts the application server process (step 614).

Deployment Specifier

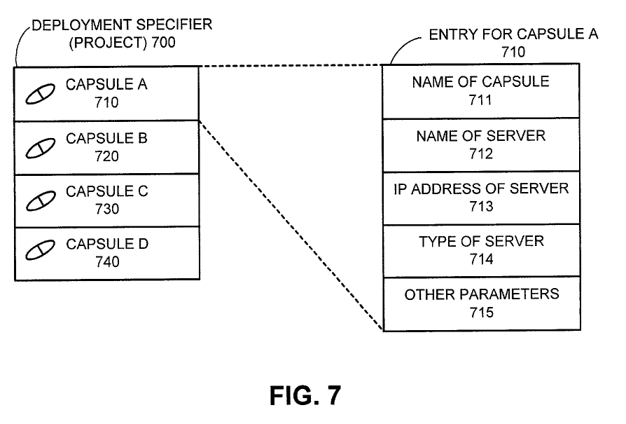

FIG. 7 illustrates the structure of a deployment specifier 700 (also referred to as a project) in accordance with an embodiment of the present invention. Deployment specifier 700 includes an entry for each capsule that makes up distributed application 108, including capsule A 710, capsule B 720, capsule C 730 and capsule D 740. The entry for capsule A 710 includes a number of data items, including the name of the capsule 711, the name of the server that the capsule is to be deployed to 712, the Internet Protocol (IP) address of the server 713, an identifier for the type/manufacturer of server 714, and possibly other parameters 715. By examining deployment specifier 700, the system is able to automatically determine where a specific capsule is to be deployed.

Deployment specifier 700 can optionally include information on dependencies between capsules. For example, if a first capsule makes a call to a second capsule, the first capsule is said to “depend” on the second capsule. If the second capsule is subsequently modified or relocated, a reference to the second capsule may have to be modified within the first capsule.

Process of Deploying a Distributed Application

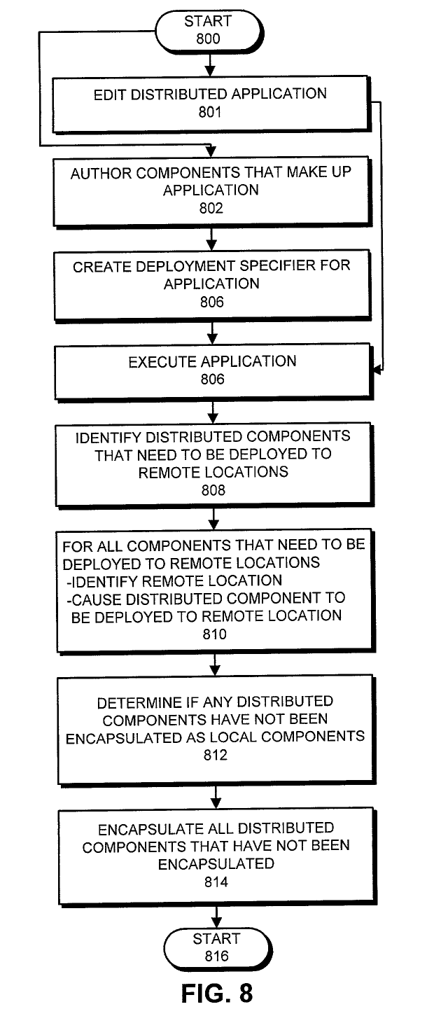

FIG. 8 is a flow chart illustrating the process of deploying distributed components that make up a distributed application in accordance with an embodiment of the present invention. An application developer working on authoring client 109 first authors or otherwise obtains components that make up the application (step 802). The application developer also creates a deployment specifier 700 for the application (step 804). This deployment specifier 700 includes information specifying where components that make up distributed application 108 are to be deployed.

Upon subsequent execution of distributed application 108, the system examines deployment specifier 700 to identify distributed components that need to be deployed to remote locations (step 808). For all components that need to be deployed to remote locations, the system obtains the identity of the remote location from deployment specifier 700 and causes the distributed component to be deployed to the remote location (step 810). Note that local components are compiled and installed locally.

The system also determines if any distributed components have not been encapsulated as local components (step 812). If so, the system encapsulates the distributed components as local components (step 814). This enables the distributed components to be accessed as if they are local components. Hence, the fact that a component is located on a remote computer system is transparent to the application developer. This allows the application developer to write code that treats distributed components as local components.

When distributed application 108 is subsequently edited (step 801) and executed (step 806) during the development process, the system determines which distributed components have been modified, and then redeploys these modified components. Note that if a component contains a reference to another component and the reference changes, the component must be redeployed with a new reference.

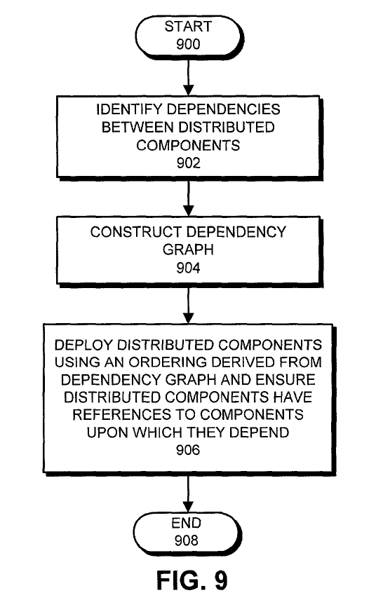

FIG. 9 is a flow chart illustrating how references between distributed components are handled during the deployment process in accordance with an embodiment of the present invention. During the deployment process, the system identifies dependencies between components (step 902). For example, if a first component makes a call into a second component, the first component is said to depend on the second component. This dependency information can be gained by examining the components, or alternatively, by examining deployment specifier 700 if such information is stored in deployment specifier 700.

Next, the system constructs a dependency graph between the components (step 904). The system then deploys the components using an ordering derived from the dependency graph, so that if a first component depends on a second component, the second component is deployed before the first component is deployed (step 906). This ensures that a reference to a component will be available if it is needed by another component. While deploying the components, the system ensures that distributed components have references to components upon which they depend.

Note that the above-described process can be slightly modified in the case where one or more components depend upon each other. In this case, the interdependent components are first deployed and then references to the interdependent components are subsequently communicated to the other interdependent components.

Example Distributed Application

FIG. 10A illustrates the structure of an exemplary distributed application 108 in accordance with an embodiment of the present invention. Distributed application 108 includes capsule A, which is a servlet that controls execution of the application on server 109. It also includes two remotely deployed capsules, capsule B and capsule C, as well as a local capsule, capsule D.

Capsule A includes a reference to capsule B. Note that this reference is followed when a behavior fires and sends a message to BINTERFACE upon receiving an event on the EXECUTE interface.

Capsule B includes a reference to capsule C. This reference is followed when a behavior fires and sends a message to CINTERFACE upon receiving an event on BINTERFACE.

Capsule C does not reference other capsules. A behavior within capsule C fires and sends a message to activate a component X within capsule C upon receiving an event on BINTERFACE.

FIG. 10B is a flow chart illustrating how the exemplary distributed application is deployed in accordance with an embodiment of the present invention. The system first determines dependencies between capsules (step 1002). The system then uses these dependencies to construct a dependency graph between components (step 1004). In this graph, component A depends on component B, and component B depends on component C.

The system initially deploys component C because no other components depend upon component C (step 1006). This involves compiling component C and then shipping component C (possibly with dependent components) to application server 114.

Next, the system deploys component B, which depends upon component C (step 1008). This involves compiling component B with a reference to component C, and then shipping component B (possibly with dependent components) to application server 112.

Next, the system deploys component A, which depends upon component B (step 1010). This involves compiling component A with a reference to component B, and then shipping component B (possibly with dependent components) to an application server, if such deployment is necessary. Note that during the development process, component A is deployed locally on authoring client 109. After the development process is complete, deployment specifier 700 can be modified to deploy component A to another application server.

Finally, the system deploys local component D. This involves compiling local component D on authoring client 109.

FIG. 10C illustrates how the exemplary distributed application 108 operates in accordance with an embodiment of the present invention. When a signal is received on the EXECUTE interface in capsule A 710 located on server 109, it causes the behavior within capsule A to fire, which generates a call to BINTERFACE. This causes the behavior in capsule B on application server 112 to fire, which generates a call to CINTERFACE. This causes the behavior in capsule C on application server 114 to fire, which activates component X within capsule C.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for interlinking distributed components during development of a distributed application, comprising:
receiving the distributed application;
automatically determining under computer control a set of dependencies between distributed components that make up the distributed application, wherein a dependency between a first distributed component and a second distributed component indicates that the first distributed component refers to the second distributed component; and
automatically ensuring under computer control that each distributed component that depends on a remote distributed component located on another computer system has a reference to the remote distributed component;
whereby a developer of the distributed application does not explicitly communicate references between the distributed components in order to interlink the distributed components.

2. The method of claim 1, wherein determining the set of dependencies involves constructing a dependency graph between distributed components that make up the distributed application.

3. The method of claim 2, further comprising deploying the distributed components using an ordering derived from the dependency graph, so that a given distributed component is only deployed after distributed components upon which the given distributed component depends have been deployed and have returned references;
whereby the given distributed component can be deployed with references to distributed components upon which it depends.

4. The method of claim 1, wherein determining the set of dependencies involves examining a deployment specifier that indicates where each of the distributed components that make up the distributed application is to be deployed.

5. The method of claim 1,
wherein the distributed application is specified in terms of a component-behavior model;
wherein the component-behavior model specifies components, which are separately deployable pieces of software that can be used to make up an application; and
wherein the component-behavior model also specifies behaviors that define a response to an event, wherein the response can include activating a component.

6. The method of claim 5, wherein activating the component involves invoking a method defined by the component.

7. The method of claim 5, wherein an event can be generated by a component or a behavior.

8. The method of claim 1,
wherein receiving the distributed application involves receiving the distributed application after the distributed application has been modified during a development process; and
wherein determining the set of dependencies involves, determining changes to the set of dependencies caused by modifications to the distributed application;
whereby only dependencies that have been changed during the development process cause new references to be communicated.

9. The method of claim 1, wherein receiving the distributed application involves:
authoring the distributed components that make up the distributed application; and
creating a deployment specifier that indicates where each of the distributed components is to be deployed.

10. The method of claim 1, wherein receiving the distributed application involves receiving the distributed application during execution of the distributed application.

11. The method of claim 1, wherein each of the distributed components can include one of:
an Enterprise JavaBean (EJB);
a Distributed Component Object Model (DCOM) object; and
a Common Object Request Broker Architecture (CORBA) object.

12. The method of claim 1, wherein a distributed programming component is an Enterprise JavaBean (EJB) that is encapsulated as a JavaBean by combining functionality of a home interface and a remote interface of the EJB into the JavaBean.

13. The method of claim 1, further comprising:
identifying any distributed components within the distributed application that need to be deployed to remote locations; and
for each distributed component that needs to be deployed, deploying the distributed component by,
identifying a remote location for the distributed component, and
causing the distributed component to be deployed to the remote location.

14. A computer-readable storage medium storing instructions that when executed by a computer cause the computer to perform a method for interlinking distributed components during development of a distributed application, the method comprising:
receiving the distributed application;
automatically determining under computer control a set of dependencies between distributed components that make up the distributed application, wherein a dependency between a first distributed component and a second distributed component indicates that the first distributed component refers to the second distributed component; and
automatically ensuring under computer control that each distributed component that depends on a remote distributed component located on another computer system has a reference to the remote distributed component;
whereby a developer of the distributed application does not explicitly communicate references between the distributed components in order to interlink the distributed components.

15. The computer-readable storage medium of claim 14, wherein determining the set of dependencies involves constructing a dependency graph between distributed components that make up the distributed application.

16. The computer-readable storage medium of claim 15, wherein the method further comprises deploying the distributed components using an ordering derived from the dependency graph, so that a given distributed component is only deployed after distributed components upon which the given distributed component depends have been deployed and have returned references;
whereby the given distributed component can be deployed with references to distributed components upon which it depends.

17. The computer-readable storage medium of claim 14, wherein determining the set of dependencies involves examining a deployment specifier that indicates where each of the distributed components that make up the distributed application is to be deployed.

18. The computer-readable storage medium of claim 14,
wherein the distributed application is specified in terms of a component-behavior model;
wherein the component-behavior model specifies components, which are separately deployable pieces of software that can be used to make up an application; and
wherein the component-behavior model also specifies behaviors that define a response to an event, wherein the response can include activating a component.

19. The computer-readable storage medium of claim 18, wherein activating the component involves invoking a method defined by the component.

20. The computer-readable storage medium of claim 18, wherein an event can be generated by a component or a behavior.

21. The computer-readable storage medium of claim 14,
wherein receiving the distributed application involves receiving the distributed application after the distributed application has been modified during a development process; and
wherein determining the set of dependencies involves, determining changes to the set of dependencies caused by modifications to the distributed application;
whereby only dependencies that have been changed during the development process cause new references to be communicated.

22. The computer-readable storage medium of claim 14, wherein receiving the distributed application involves:
authoring the distributed components that make up the distributed application; and
creating a deployment specifier that indicates where each of the distributed components is to be deployed.

23. The computer-readable storage medium of claim 14, wherein receiving the distributed application involves receiving the distributed application during execution of the distributed application.

24. The computer-readable storage medium of claim 14, wherein each of the distributed components can include one of:
an Enterprise JavaBean (EJB);
a Distributed Component Object Model (DCOM) object; and
a Common Object Request Broker Architecture (CORBA) object.

25. The computer-readable storage medium of claim 14, wherein a distributed programming component is an Enterprise JavaBean (EJB) that is encapsulated as a JavaBean by combining functionality of a home interface and a remote interface of the EJB into the JavaBean.

26. The computer-readable storage medium of claim 14, wherein the method further comprises:
identifying any distributed components within the distributed application that need to be deployed to remote locations; and
for each distributed component that needs to be deployed, deploying the distributed component by,
identifying a remote location for the distributed component, and
causing the distributed component to be deployed to the remote location.

27. An apparatus that interlinks distributed components during development of a distributed application, comprising:
a receiving mechanism that is configured to receive the distributed application; and
an interlinking mechanism that is configured to,
determine a set of dependencies between distributed components that make up the distributed application, wherein a dependency between a first distributed component and a second distributed component indicates that the first distributed component refers to the second distributed component, and to
ensure that each distributed component that depends on a remote distributed component located on another computer system has a reference to the remote distributed component;
whereby a developer of the distributed application does not explicitly communicate references between the distributed components in order to interlink the distributed components.

28. The apparatus of claim 27, wherein the interlinking mechanism is configured to construct a dependency graph between distributed components that make up the distributed application.

29. The apparatus of claim 28, further comprising a deployment mechanism that is configured to deploy the distributed components using an ordering derived from the dependency graph, so that a given distributed component is only deployed after distributed components upon which the given distributed component depends have been deployed and have returned references;
whereby the given distributed component can be deployed with references to distributed components upon which it depends.

30. The apparatus of claim 27, wherein the interlinking mechanism is configured to examine a deployment specifier that indicates where each of the distributed components that make up the distributed application is to be deployed.

31. The apparatus of claim 27,
wherein the distributed application is specified in terms of a component-behavior model;
wherein the component-behavior model specifies components, which are separately deployable pieces of software that can be used to make up an application; and
wherein the component-behavior model also specifies behaviors that define a response to an event, wherein the response can include activating a component.

32. The apparatus of claim 31, wherein activating the component involves invoking a method defined by the component.

33. The apparatus of claim 31, wherein an event can be generated by a component or a behavior.

34. The apparatus of claim 27,
wherein the receiving mechanism is configured to receive the distributed application after the distributed application has been modified during a development process; and
wherein the interlinking mechanism is configured to detect changes to the set of dependencies caused by modifications to the distributed application;
whereby only dependencies that have been changed during the development process cause new references to be communicated.

35. The apparatus of claim 27, further comprising an authoring mechanism that is configured to facilitate authoring the distributed components that make up the distributed application, and to facilitate creating a deployment specifier that indicates where each of the distributed components is to be deployed.

36. The apparatus of claim 27, wherein the receiving mechanism is configured to receive the distributed application during execution of the distributed application.

37. The apparatus of claim 27, wherein each of the distributed components can include one of:
an Enterprise JavaBean (EJB);
a Distributed Component Object Model (DCOM) object; and
a Common Object Request Broker Architecture (CORBA) object.

38. The apparatus of claim 27, wherein a distributed programming component is an Enterprise JavaBean (EJB) that is encapsulated as a JavaBean by combining functionality of a home interface and a remote interface of the EJB into the JavaBean.

39. The apparatus of claim 27, further comprising a deployment mechanism that is configured to identify distributed components within the distributed application that need to be deployed to remote locations;
wherein for each distributed component that needs to be deployed, the deployment mechanism is configured to
identify a remote location for the distributed component, and to
cause the distributed component to be deployed to the remote location.

40. A method for deploying a component-behavior model within a distributed computer system, comprising:
receiving a specification for the component-behavior model;
wherein the component-behavior model specifies components, which are separately deployable pieces of software that can be used to make up an application;
wherein the component-behavior model also specifies behaviors that activate components in response to events generated by components or behaviors;
determining a set of dependencies between components that make up the component-behavior model, wherein a dependency between a first component and a second component indicates that the first component refers to the second component; and
ensuring that each component that depends on a remote component located on another computer system has a reference to the remote component.

41. The method of claim 40, wherein ensuring that each component that depends on a remote component that has a reference to the remote component involves examining a deployment specifier that indicates where each of the components within the component-behavior model is to be deployed.

42. A computer-readable storage medium storing instructions that when executed by a computer cause the computer to perform a method for deploying a component-behavior model within a distributed computer system, the method comprising:
receiving a specification for the component-behavior model;
wherein the component-behavior model specifies components, which are separately deployable pieces of software that can be used to make up an application;
wherein the component-behavior model also specifies behaviors that activate components in response to events generated by components or behaviors;
determining a set of dependencies between components that make up the component-behavior model, wherein a dependency between a first component and a second component indicates that the first component refers to the second component; and
ensuring that each component that depends on a remote component located on another computer system has a reference to the remote component.

43. The computer-readable storage medium of claim 42, wherein ensuring that each component that depends on a remote component that has a reference to the remote component involves examining a deployment specifier that indicates where each of the components within the component-behavior model is to be deployed.

44. An apparatus that deploys a component-behavior model within a distributed computer system, comprising:
a receiving mechanism that is configured to receive a specification for the component-behavior model;
wherein the component-behavior model specifies components, which are separately deployable pieces of software that can be used to make up an application;
wherein the component-behavior model also specifies behaviors that activate components in response to events generated by components or behaviors; and
an interlinking mechanism that is configured to,
determine a set of dependencies between components that make up the component-behavior model, wherein a dependency between a first component and a second component indicates that the first component refers to the second component, and to
ensure that each component that depends on a remote component located on another computer system has a reference to the remote component.

45. The apparatus of claim 44, wherein the interlinking mechanism is configured to examine a deployment specifier that indicates where each of the components within the component-behavior model is to be deployed.
